(19) United States
(12) Patent Application Publication
(10) Pub. No.: US 2025/0162536 A1
(43) Pub. Date: May 22, 2025

(54) SEAT BELT AND DETECTION SYSTEM

(71) Applicant: Autoliv Development AB, Vargarda (SE)

(72) Inventors: Mihaela COSTEA, Brasov (RO); Willi WELZ, Veghel (NL); Kai-Stephan MUELLER, Oelixdorf (DE); Crina TIRON, Brasov (RO); Ioan IONITA, Brasov (RO)

(21) Appl. No.: 18/730,635

(22) PCT Filed: Jan. 24, 2023
(86) PCT No.: PCT/EP2023/051603

§ 371 Date: Jul. 19, 2024

(30) Foreign Application Priority Data
Jan. 25, 2022 (DE) 10 2022 101 717.6

(51) Int. Cl. B60R 22/48

(52) U.S. Cl. CPC B60R 22/48; B60R 2022/485

(57) ABSTRACT

A safety belt for a motor vehicle, the safety belt having markings that are optically detectable in the infrared spectral range. The marking comprises edge markings of the two edges of the safety belt, and the marking has a marking that is asymmetrical to the longitudinal axis of the safety belt. Further-more, the invention relates to a detection system for detecting a state of use of a corresponding safety belt.

The present invention relates to a safety belt according to the preamble of claim 1 and to a detection system for detecting the state of use of a safety belt according to the preamble of claim 10.

Safety belt warning systems are regularly used in motor vehicles, which systems check whether a safety belt is being worn when a passenger is occupying a vehicle seat. Such belt warning systems detect, for example, the insertion state of the belt tongue. It can happen that the occupant is not wearing the safety belt at all, but that the belt warning system mistakes the insertion state with a different insertion tongue. It is also possible for the occupant to be sitting on the inserted safety belt or for the safety belt to run between the back and the backrest. In addition, situations are for example possible in which the chest strap runs under the arm. To increase passenger safety, and possibly also to control active safety mechanisms, such as airbags and belt tensioners, in vehicles optical detection systems are known which are designed to detect the usage status of the safety belt, for example whether it is properly fastened, or is not fastened or is improperly fastened. The corresponding detection often takes place in the invisible, infrared light spectral range, so that for example corresponding detection is also possible at night without blinding the occupant.

The object of the present invention is to provide a safety belt which is particularly suitable for optical detection of the state of use, as well as a corresponding detection system with such a safety belt.

The object is achieved by the features of the independent claims. Further preferred developments can be taken from the dependent claims, the figures and the associated description.

To achieve the object, a safety belt for a motor vehicle is proposed, wherein the safety belt has markings which are optically detectable in the infrared spectral range. The marking includes edge markings of both edges of the safety belt, and the marking has a marking asymmetrical to the longitudinal axis of the safety belt.

Due to the corresponding distribution of the marking on the safety belt, the safety belt is particularly suitable for optical detection. The marking of the safety belt, which can also be referred to as a pattern, can be particularly easily distinguished from the background, usually from the occupant or clothing, when detected by automatic systems. The edge marking serves in particular to delimit the safety belt from the occupant's clothing. Furthermore, the edge markings of the marking on the safety belt are as far apart from one another as possible and therefore achieve a maximized resolution and optimized recognizability of the position of the safety belt. The marking of the safety belt, which is asymmetrical to the longitudinal axis, is particularly suitable for automatic detection by a camera sensitive to the infrared spectrum, preferably the near-infrared spectrum, and a corresponding data processing device. Among other things, this improves the distinguishability from a passenger's clothing, such as a striped T-shirt.

The marking may be lighter or darker in the infrared spectrum than the other unmarked areas of the safety belt. Preferably, in the visible spectrum the human eye cannot see any difference between the marking and the other unmarked areas of the safety belt.

The corresponding marking is preferably present on both sides of the safety belt so that twisting of the safety belt does not impair the functionality of the marking.

It is further proposed that the edge marking of both edges is formed by longitudinal stripes. Longitudinal stripes run parallel to the longitudinal axis of the safety belt and are particularly suitable for forming the edge marking. A longitudinal stripe is preferably uninterrupted. In other embodiments, however, dashed, dotted or dash-dotted longitudinal stripes are also possible.

According to a further development, it is proposed that the two longitudinal stripes of the edge marking are identical. The two edge markings therefore preferably have the same width and the same reflection and absorption behavior.

It is further proposed that the marking has at least three longitudinal stripes. This enables the formation of a pattern that can be easily distinguished from the surrounding environment and recognized using a camera sensitive to the infrared spectrum and a corresponding data processing device.

According to a further development, it is proposed that at least one longitudinal stripe of the marking is arranged between the edge markings. The at least one longitudinal stripe between the edge marking can also preferably be arranged asymmetrically to the longitudinal axis of the safety belt in a simple manner, so that different distances of the longitudinal stripe to the edge of the safety belt, to the edge marking and/or to the longitudinal stripes of the edge marking result.

It is further proposed that two longitudinal stripes of the marking are arranged between the edge marking, wherein the shape of these two longitudinal stripes differs from each other. The characteristics of the longitudinal stripes preferably include the width and/or the reflection and absorption behavior in the infrared spectrum. Furthermore, a longitudinal stripe can be dashed, dotted or dash-dotted, for example. In a possible further development, it is proposed that two longitudinal stripes of the marking are arranged between the edge marking, wherein these two longitudinal stripes are dashed. In this case, the longitudinal stripes between the edge marking can be viewed as rectangles arranged in a row. Such longitudinal stripes between the edge markings can enable improved detectability in the event of a rotated seat.

According to a further development, it is proposed that the marking preferably has transverse bar markings which connect the edge markings of both edges of the safety belt. This allows a wide pattern with interrupted structures to be formed on the safety belt, which can further increase the detectability of the course of the belt. In this case, the marking preferably leaves open rectangles, in particular when both edges are marked by longitudinal stripes which are each bordered at the top and bottom by a transverse bar marking. Furthermore, in the case of a further longitudinal stripe between the edge markings, two rectangles arranged next to one another are preferably left open by the marking. For example, in the case of two longitudinal stripes between the edge marking, preferably three rectangles arranged next to each other are left open by the marking. The rectangles preferably do not have a recognizable center line perpendicularly parallel to the longitudinal axis. In principle, the marking can have a lower or an increased absorption capacity in the infrared spectral range compared to the areas not covered by the marking. Improved detectability can be achieved especially in the case of a rotated seat, since narrow edge markings can have reduced detectability in this case.

According to a further development, it is proposed that the safety belt is produced from at least two different yarns, each having different optical properties in the infrared spectral range. The optical properties in the infrared spectral range relate in particular to the reflection and absorption behavior.

A safety belt with a corresponding marking can, for example, be made using the weave types twill, plain, satin, double, or hollow weave. For example, yarns with 550 dtex to 1100 dtex can be used as weft thread and 1100 dtex to 2200 dtex as warp thread.

A corresponding yarn with optically different properties in the infrared spectrum can be achieved for example by adding a material that influences the properties in the infrared spectrum before the yarn is produced from a melt. A corresponding additive can, for example, be added to a polyester granulate before the melt and the production of polyester fibers. Therefore, the yarn already has the corresponding optical properties, which are also present over the entire volume, so that erosion of the surface, for example through years of use, does not cause any significant change in the optical properties.

In alternative embodiments, the marking on the safety belt can be achieved for example by coating a yarn before manufacturing the safety belt. Furthermore, in alternative embodiments, the marking can be done by printing or coating the safety belt.

Furthermore, to achieve the object of the invention, a detection system for detecting a state of use of at least one safety belt according to one of claims 1 to 9 in a motor vehicle is proposed, which system comprises at least one camera which is set up to record images in the infrared spectral range, wherein the camera is designed to record images of the at least one safety belt, and an electronic data processing device. The data processing device is designed to detect the safety belt and the state of use of the safety belt by an occupant.

In advantageous embodiments, the detection system can detect the state of use of a safety belt or the fastening state on multiple seats in a vehicle.

According to a further development, it is proposed that the data processing device is designed to detect the asymmetrical marking to the longitudinal axis of the safety belt and the edge marking.

It is further proposed that the data processing device is designed to determine the seating position and/or the size of an occupant from the detection of the safety belt.

The invention is explained below using preferred embodiments with reference to the accompanying figures. In the figures:

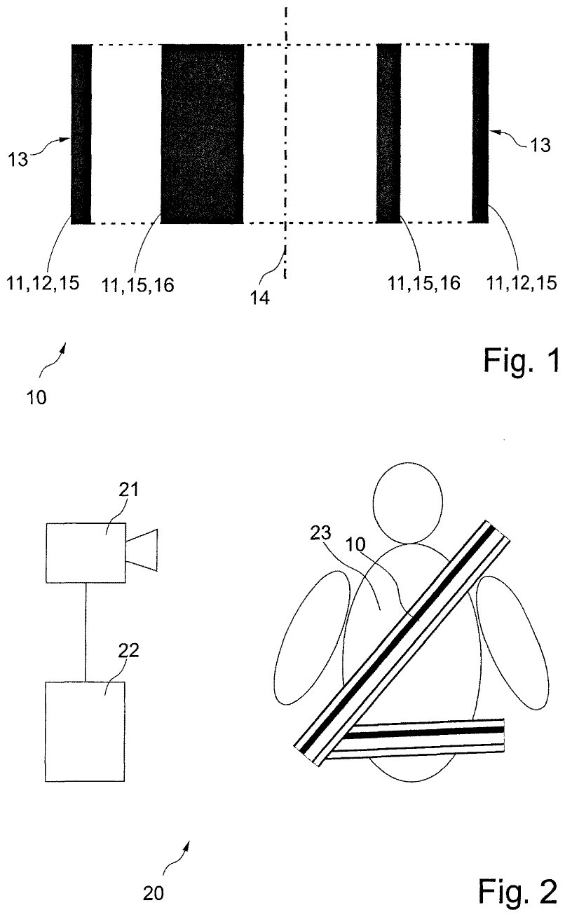

FIG. 1 shows a portion of a safety belt with marking;

FIG. 2 shows a detection system with a camera, data processing device, and a safety belt;

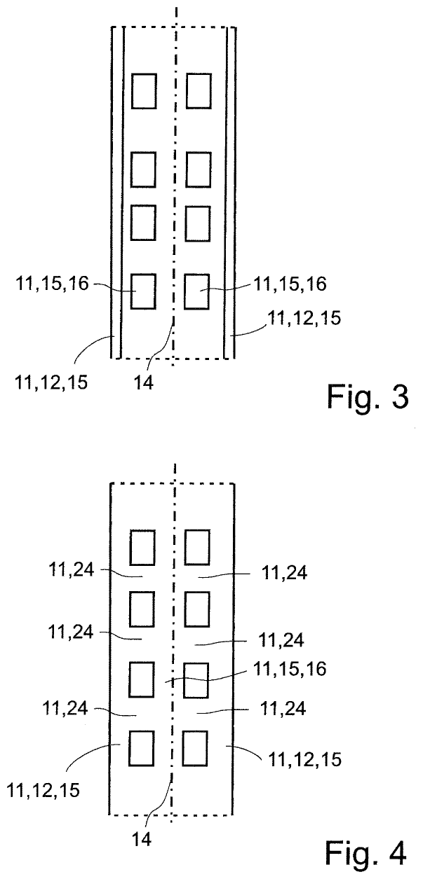

FIG. 3 shows another portion of a safety belt with two dashed longitudinal stripes in the middle; and

FIG. 4 shows another portion of a safety belt with a longitudinal stripe in the middle and transverse bar markings.

FIG. 1 shows a schematic embodiment of a portion of a safety belt 10 for a motor vehicle with markings 11. The illustration in FIG. 1 and also in FIG. 2 shows the safety belt 10 in an infrared spectral range, so that the markings 11 are optically detectable and recognizable. In the visible spectral range, the marking 11 is therefore preferably not visible to the human eye. The safety belt 10 extends along its longitudinal axis 14 and has an edge 13 on each side.

The edges 13 are marked by an edge marking 12 in the form of a longitudinal stripe 15. In this advantageous embodiment, the two edge markings 12 have the same width. Between the edge markings 12, an asymmetrical marking 16 in the form of two longitudinal stripes 15 is provided, so that the safety belt 10 has a total of four longitudinal stripes 15 as marking 11. The two longitudinal stripes 15 of the asymmetrical marking 16 have a different width and are each arranged on one side of the longitudinal axis 14 on the safety belt 10.

In this embodiment, the safety belt 10 has a total width between the two edges 13 of 50 mm, wherein the edge marking 12 has a width of 3 mm in each case. The left longitudinal stripe 15 of the asymmetric marking 16 in the illustration in FIG. 1 has, for example, a width of 10 mm with a distance of 7 mm to the left edge marking 12. The right longitudinal stripe 15 has a width of 5 mm and is arranged at a distance of 7 mm from the right edge marking 12.

In this embodiment, the marking 11 is shown darker than the other areas of the safety belt 10. In this embodiment, the marking 11 has a higher absorption capacity in the infrared spectral range and therefore appears darker in the infrared image of FIG. 1. However, in alternative embodiments, it is possible that the marking 11 has a lower absorption capacity in the infrared spectral range than the other unmarked areas of the safety belt 10 and would therefore appear brighter.

FIG. 2 schematically shows an embodiment of a detection system 20 for detecting the fastening state of a safety belt 10. The detection system 20 has a camera 21 for detecting at least part of an occupant 23 on a vehicle seat, wherein the camera 21 takes images in the infrared spectral range. Thus, the camera 21 can detect the marking 11 of the safety belt 10, which can be detected in the infrared spectral range.

In possible embodiments, the detection system 20 additionally has an infrared light source which illuminates the safety belt 10 in the infrared spectral range.

The image data captured by the camera 21 are evaluated by a data processing device 22, wherein the data processing device 22 detects the safety belt 10 and the state of use of the safety belt 10 by the occupant 23. As shown in the schematic representation in FIG. 2, the occupant 23 wears the safety belt 10, so that the detection system 20 detects that the safety belt 10 is being worn properly, i.e. that it is in a proper state of use. Accordingly, for example, an optical or acoustic safety belt warning indicator can be switched off by the data processing device 22.

In advantageous embodiments, the data processing device 22 can use the proposed marking 11 of the safety belt 10 and the image recording in the IR spectrum to determine the seating position and/or the size of the occupant in addition to deviations from an intended belt fastening state, which can be used, for example, in active safety systems.

In FIG. 3, another embodiment of a portion of a safety belt 10 for a motor vehicle with markings 11 is shown schematically. Between the edge markings 12, two longitudinal stripes 15 are provided as asymmetrical markings 16 between the edge marking 12, which are designed in dashed lines, so that the marking 11 in the middle region of the safety belt 10 represents two parallel rows of rectangles.

A further schematic representation of an embodiment is shown in FIG. 4, in which a longitudinal stripe 15 is arranged as an asymmetric marking 16 between the edge markings 12. The longitudinal stripe 15 between the edge markings 12 is connected to the two longitudinal stripes 15 of the edge marking 12 via transverse webs 24. Thus, two rows of rectangles arranged parallel to the longitudinal axis 14 can be recognized. In particular in this embodiment, the marking 11 may appear darker in the infrared spectral range than the areas outside the marking 11, so that the rectangles appear brighter in the infrared spectral range.

1. A safety belt for a motor vehicle, the safety belt having markings which can be optically detected in the infrared spectral range, wherein:
the marking comprises edge markings of both edges of the safety belt, and
the marking has a marking which is asymmetrical to the longitudinal axis of the safety belt.

2. The safety belt according to claim 1, wherein the edge marking of both edges is formed by longitudinal stripes.

3. The safety belt according to claim 1, wherein the two longitudinal stripes of the edge marking are identical.

4. The safety belt according to claim 1, wherein the marking has at least three longitudinal stripes.

5. The safety belt according to claim 1, wherein at least one longitudinal stripe of the marking is arranged between the edge marking.

6. The safety belt according to claim 1, wherein two longitudinal stripes of the marking are arranged between the edge marking, wherein the shape of these two longitudinal stripes differs from each other.

7. The safety belt according to claim 1, wherein two longitudinal stripes of the marking are arranged between the edge marking, wherein these two longitudinal stripes are dashed.

8. The safety belt according to claim 1, wherein the marking preferably has transverse bar markings which connect the edge markings of both edges of the safety belt to one another.

9. The safety belt according to claim 1, wherein the safety belt is produced from at least two different yarns, each having different optical properties in the infrared spectral range.

10. A detection system for detecting the state of use of a safety belt according to claim 1 in a motor vehicle, comprising:
at least one camera which is designed to capture images in the infrared spectral range,
the camera being designed to capture images of the at least one safety belt, and comprising
an electronic data processing device, wherein
the data processing device is designed to recognize the safety belt and the state of use of the safety belt by an occupant.

11. The detection system according to claim 10, wherein the data processing device is designed to detect the marking which is asymmetrical with respect to the longitudinal axis of the safety belt and the edge marking.

12. The detection system according to claim 10, wherein the data processing device is designed to determine the seating position and/or the size of an occupant from the detection of the safety belt.
